(19) United States
(12) Patent Application Publication
(10) Pub. No.: US 2015/0151522 A1
(43) Pub. Date: Jun. 4, 2015

(54) METHOD FOR IMPROVING ADHESION OF POLYURETHANE ADHESIVE TO POLYESTER BASED LAMINATE WITHOUT SURFACE PREPARATION

(71) Applicant: Henkel lP & Holding GmbH, Duesseldorf (DE)

(72) Inventors: Jayesh P. Shah, Plaistow, NH (US); Sankar Govindarajan, Tamil Nadu, IN (US)

(21) Appl. No.: 14/618,017

(22) Filed: Feb. 10, 2015

Related U.S. Application Data
(63) Continuation of application No. PCT/US2013/050587, filed on Jul. 16, 2013.
(60) Provisional application No. 61/681,919, filed on Aug. 10, 2012.

(51) Int. Cl. B32B 27/36; C09J 133/06; B32B 37/12; B32B 7/12; B32B 27/20

(52) U.S. Cl. CPC B32B 27/36; B32B 7/12; B32B 27/20; B32B 37/12; C09J 133/066; B32B 2255/10; B32B 2255/26; B32B 2262/101

(57) ABSTRACT

Disclosed is a composite laminate made from unsaturated polyester resin that can be bonded using polyurethane adhesive without secondary treatment of the composite laminate and with improved bond strength and failure mode. Also disclosed are methods of making such composite laminates.

The present disclosure relates generally to composite laminates made from polyester resins that can be bonded using polyurethane adhesive without secondary treatment of the composite laminate and with improved bond strength. Also disclosed are methods of making such composite laminates.

Composite laminates typically comprise multiple overlying layers of a reinforcement saturated with a resin composition. The composite laminate may have a finish surface comprised primarily of cured resin, call gelcoat, for aesthetic purposes.

If used, a finish layer of resin composition or gelcoat without reinforcement is applied to a prepared mold. A first layer of resin and reinforcement is positioned in, or over, this finish layer or prepared mold and subsequent layers of resin and reinforcement are laminated or overlaid to the previous layer until a desired thickness and shape has been produced. The resin composition is cured or crosslinked to form a composite laminate comprising multiple layers of reinforcement and cured resin and the composite laminate is separated from the mold.

The reinforcement and resin composition in each layer can be applied separately (reinforcement first that is subsequently saturated with uncured resin composition) or simultaneously (reinforcement preimpregnated with uncured resin composition applied to a previous layer or a reinforcement and uncured resin composition mixture applied to a previous layer or mold by spraying or injection).

Composite laminates and related processes are referred to under a number of different names and abbreviations, including contact polyesters, SMC (Sheet Molding Compound), BMC (Bulk Molding Compound), RTM (Resin Transfer Molding), AMC (Adapted Molding Compound), RIM (Resin Injection Molding), GRP (Glass Reinforced Plastics) and FRP (Fiber Reinforced Polymers).

Unsaturated polyester based resin compositions are normally air-inhibited when cured in air, which means the resin composition remains partially uncured (sticky or tacky) on the surface where it is exposed to oxygen in the air. The outermost layer of the finished composite laminate will undesirably remain uncured and tacky. To overcome this effect, wax can be added to the polyester resin composition. While curing, the wax migrates to the surface and forms a thin layer or film which acts as a barrier to prevent air and oxygen from reacting with unsaturated polyester so that the resin composition can fully cure to a nontacky condition. This technique works but requires removal of the wax after curing. Any residual wax will deleteriously degrade adhesion of that layer to the adjacent layer or bonding of that layer to a substrate. Wax can be removed by sanding, however this is very labor intensive, produces particles of reinforcement and cured resin composition in the air which is a possible health risk and can force wax into the laminate.

The reinforcement can comprise chopped fibers, continuous fibers, a nonwoven mat of discontinuous fibers, a woven fabric of glass fibers, an arrangement of fibers or other form that imparts desired structural properties in the molded object. Fibers can be based on silica (glass), synthetic polymers and inorganic materials or compounds such as boron and carbon (graphite). Materials such as foam, end core balsa and synthetic or metal honeycomb are other useful reinforcements. Reinforcement typically has porosity to allow resin composition to penetrate into the reinforcement.

Multiple composite laminates can be joined to form complicated composite articles. For example, a hull laminate can be joined to a deck laminate and a superstructure laminate to form a boat. Composite articles are used in many industries including automotive, aerospace, boats, wind turbines and consumer products to replace unitary materials such as wood or metal, thereby reducing weight, resolving corrosion problems, increasing strength and enabling new forms. The joining of multiple composite laminates to form a single composite article by adhesive bonding is often the only means available because classic techniques such as welding, fastening and bolting are not suitable for use with composite articles. Bonding of composite laminates is therefore critical to strength of the finished composite article.

Polyurethane adhesives have many desirable properties including high strength, quick cure and ease of use. However, polyurethane adhesives do not bond well to the partially cured, tacky surface of a composite laminate made with unsaturated polyester resin. Thus a user desiring to bond composite laminates with polyurethane adhesives is required to accept lower bond strength or secondarily treat the composite laminate by grinding away the tacky surfaces to expose fully cured resin and/or treat the composite laminates with primers or adhesion promoters. It would be desirable to provide composite laminates made from unsaturated polyester resins that can be bonded using polyurethane adhesive without secondary treatments and with improved bond strength.

### SUMMARY

One aspect of the disclosure provides an unsaturated polyester resin composition that, when cured, can be bonded using polyurethane adhesive without secondary treatments and with improved bond strength.

One aspect of the disclosure provides a composite laminate made using an unsaturated polyester resin composition that, when cured, can be bonded using polyurethane adhesive without secondary treatments and with improved bond strength.

One aspect of the disclosure provides a method of improving bond strength of cured composite laminates made from an unsaturated polyester resin composition to polyurethane adhesive without secondary treatments and with improved bond strength.

The disclosed compounds include any and all isomers and steroisomers. In general, unless otherwise explicitly stated the disclosed materials and processes may be alternately formulated to comprise, consist of, or consist essentially of, any appropriate components, moieties or steps herein disclosed. The disclosed materials and processes may additionally, or alternatively, be formulated so as to be devoid, or substantially free, of any components, materials, ingredients, adjuvants, moieties, species and steps used in the prior art compositions or that are otherwise not necessary to the achievement of the function and/or objective of the present disclosure.

When the word “about” is used herein it is meant that the amount or condition it modifies can vary some beyond the stated amount so long as the function and/or objective of the disclosure are realized. The skilled artisan understands that there is seldom time to fully explore the extent of any area and expects that the disclosed result might extend, at least somewhat, beyond one or more of the disclosed limits. Later, having the benefit of this disclosure and understanding the concept and embodiments disclosed herein, a person of ordinary skill can, without inventive effort, explore beyond the disclosed limits and, when embodiments are found to be without any unexpected characteristics, those embodiments are within the meaning of the term about as used herein.

### DETAILED DESCRIPTION

Any known reinforcement that provides desired physical properties to the resulting composite laminate and composite article can be used. Examples of some suitable reinforcements include chopped fibers, continuous fibers, a nonwoven mat of discontinuous fibers, a nonwoven mat of continuous fibers, a woven fabric of continuous fibers, an arrangement of fibers such as a bundle or tow or other form. Fibers can be based on silica (glass), synthetic polymers such as polyester, aramid or KEVLAR, and inorganic materials or compounds such as boron and carbon (graphite). Materials such as foam, end core balsa and synthetic polymer honeycomb or metal honeycomb are other useful reinforcements.

Resin composition as used herein refers to a composition based on an unsaturated polyester resin, vinyl ester resin, acrylates and methacrylate based resins. The resin composition excludes compositions based on other reactive chemistries such as epoxy, and polyurethane. The resin composition comprises unsaturated polyester resin and unsaturated monomer having a hydroxyl functional group. The uncured resin composition is typically a liquid having a viscosity selected based on method of use.

Unsaturated polyester resins are unsaturated resins formed by the condensation reaction of saturated or unsaturated dibasic organic acids and polyhydric alcohols. Some typical polyhydric alcohols are glycols such as ethylene glycol. Some typical dibasic organic acids are phthalic acid and maleic acid. The resin composition can comprise about 50 wt % to about 99 wt % unsaturated polyester resin. Advantageously, the resin composition can comprise about 70 wt % to about 99 wt % unsaturated polyester resin and more advantageously, the resin composition can comprise about 90 wt % to about 99 wt % unsaturated polyester resin.

The resin composition comprises at least one unsaturated monomer having a hydroxyl functional group. Examples of useful unsaturated monomers include hydroxyl functional (meth)acrylates. Saturated polyester resin, phenoxy resin, higher molecular weight epoxy resin which contain secondary pendant hydroxyl groups may also be useful as the unsaturated monomer having a hydroxyl functional group. The resin composition can comprise about 1 wt % to about 50 wt % unsaturated monomer having a hydroxyl functional group. Advantageously, the resin composition can comprise about 1 wt % to about 22 wt % unsaturated monomer having a hydroxyl functional group and more advantageously can comprise about 1 wt % to about 10 wt % unsaturated monomer having a hydroxyl functional group.

Examples of useful hydroxyl functional (meth)acrylates include glycerol monomethacrylate; 2-hydroxy methacrylate; 2-hydroxyethyl acrylate (HEA); 2-hydroxyethyl methacrylate (HEMA); N-(2-hydroxypropyl)methacrylamide; 3-hydroxypropyl acrylate; hydroxypropyl methacrylate; hydroxyhexyl acrylate; hydroxyoctyl methacrylate; pentaerythritol triacrylate; poly(propylene glycol) monomethacrylate; poly(propyleneglycol) dimethacrylate; 4-methacryloxy-2-hydroxybenzophenone; poly(ethylene glycol)-monomethacrylate; poly(ethylene glycol)-dimethacrylate; poly(ethylene glycol)-diacrylate; poly(ethylene glycol)-monomethylether monomethacrylate.

The resin composition typically comprises a diluent such as styrene to lower the viscosity of the resin. The resin composition can optionally include other additives known in the laminating art to provide desired properties to the resin. Examples of such optional additives include diluents and reactive diluents to reduce viscosity, thixotropes such as silica to increase viscosity, air release agents, accelerators such as amines or metal salts to modify cure rate, adhesion promoters, flame retardants etc.

It is possible to use a commercially available unsaturated polyester resin composition to which the unsaturated monomer having a hydroxyl functional group is added.

A peroxide initiator is added to the resin composition to generate free radicals to initiate free radical polymerization of the resin. Useful free radical initiators include organic peroxides such as benzoyl peroxide or methyl ethyl ketone peroxide. The free radicals react with double bonds present in unsaturated resin and monomer like styrene and propagate cross linking of components in the resin composition. As cross linking continues the resin composition gels and cures to an irreversible solid state with generation of heat.

There are a number of known processes that utilize reinforcement and unsaturated polyester resin compositions to form composite laminates. For simplicity a layup process will be described. However, the disclosed resin composition can be used in any known process to provide a composite laminate having improved bond strength to polyurethane adhesive without requiring secondary treatment of the tacky composite surface.

An unsaturated polyester resin composition comprising an unsaturated monomer having a hydroxyl functional group is provided. A source of free radicals such as organic peroxide is homogeneously mixed into the resin composition to prepare a catalyzed, uncured resin composition. The amount of organic peroxide used is sufficient to provide the mixed resin composition with a desired gel (working) time and cure time.

It is believed that during curing of the resin composition the unsaturated monomer having a hydroxyl functional group copolymerizes with the unsaturated polyester resin to provide a cured resin composition with reactive primary or secondary hydroxyl groups at the partially cured and tacky surface. The reactive primary or secondary hydroxyl groups can react with isocyanate moieties in a polyurethane adhesive to form an improved bond between the partially cured and tacky polyester resin surface and the polyurethane adhesive.

A mold is prepared by coating the mold surface with a release agent to prevent the cured resin composition from bonding to the mold surface. A finish layer of gelcoat may optionally be applied to the coated mold surface.

A first portion of reinforcement is placed in the prepared mold. Catalyzed, uncured resin composition is disposed on the reinforcement and worked into spaces in the reinforcement by brushing or rolling. This provides a first layer of reinforcement and uncured resin. A second portion of reinforcement is placed on the first layer of reinforcement and uncured resin. Additional catalyzed, uncured resin composition is disposed on the second portion of reinforcement and worked into spaces in the reinforcement by brushing or rolling to displace air to provide a second layer of reinforcement and uncured resin. The catalyzed resin composition is crosslinking during the lay up process. This process is continued until a first composite laminate is formed by the layers of reinforcement and resin composition. The first composite laminate is allowed to partially cure and removed from the mold. The first composite laminate will fully cure in about 3 to about 96 hours. The surface of the first composite laminate that was adjacent the mold (mold surface) is protected from oxygen exposure and will be fully cured. The surface of the first composite laminate that was opposite the mold (exposed surface) will be exposed to air and oxygen and therefore will be partially uncured at the surface and tacky.

The first composite laminate can be stored until needed or used when removed from the mold. Polyurethane adhesive is disposed on the first composite laminate exposed surface. As used herein secondary treatment includes operations such as grinding away the tacky exposed surface or treatment of the exposed surface with a primer, solvent, or adhesion promoter. Secondary treatment of a composite laminate made using the disclosed resin composition is not required and is desirably avoided. A skilled person understands how to choose a suitable polyurethane adhesive based on the application. Useful polyurethane adhesives are commercially available from Henkel Corporation, US. The first composite laminate and adhesive is placed on a substrate and the adhesive is allowed to cure to irreversibly bond the first composite laminate to the substrate. Typical polyurethane adhesive cure times are about 12 to about 96 hours. The substrate can be a second composite laminate, metal, polymer, foam, glass, wood or other material.

### EXAMPLES

The following examples are included for purposes of illustration so that the disclosure may be more readily understood and are in no way intended to limit the scope of the disclosure unless otherwise specifically indicated.

The following materials were used in the Examples.

ORT Gelcoat—a commercially available, curable finish layer resin composition available from FGI, division of Nuplex Industries (Aust) Pty ltd.-14, Clear view Place, Brookvale, NSW 2100, New Zealand, Nuplex Industries Ltd. 12 Industried Rd, Penrose, Auckland.

NOROX MEKP-925-H—a commercially available catalyst for ORT Gelcoat available from FGI, division of Nuplex Industries (Aust) Pty ltd.-14, Clear view Place, Brookvale, NSW 2100, New Zealand, Nuplex Industries Ltd. 12 Industried Rd, Penrose, Auckland.

ESCON F61325 NT—a commercially available air inhibited unsaturated polyester resin available from FGI, division of Nuplex Industries (Aust) Pty ltd.-14, Clear view Place, Brookvale, NSW 2100, New Zealand, Nuplex Industries Ltd. 12 Industried Rd, Penrose, Auckland. This resin contains no wax or other air barrier former.

CUROX-M340—a commercially available polyester resin catalyst available from FGI, division of Nuplex Industries (Aust) Pty ltd.-14, Clear view Place, Brookvale, NSW 2100, New Zealand, Nuplex Industries Ltd. 12 Industried Rd, Penrose, Auckland.

HEMA—hydroxyethyl methacrylate, an unsaturated monomer having a hydroxyl functional group.

MACROPLAST UK 8101/UK 5400—a commercially available two part polyurethane adhesive available from Henkel AG& Co. KGaA, Dusseldorf, Germany.

### Example 1 (Comparative)

A composite laminate of chopped glass fiber and unsaturated polyester resin was prepared as follows. A glass plate was treated with a commercial mold release agent to form a prepared mold. ORT Gelcoat was mixed with 3% by weight of Norox MEKP-925-H and the mixture was applied to the prepared mold. The gelcoat mixture was allowed to cure for 30 minutes at ambient temperature to form a finish layer. A catalyzed resin composition was prepared by mixing ESCON F61325 NT unsaturated polyester resin with 3% by wt of CUROX-M340. The catalyzed resin composition of Example 1 did not contain an unsaturated monomer having a hydroxyl functional group. The catalyzed resin composition was applied over the cured gelcoat finish layer. Chopped glass fiber was disposed over the applied resin composition and additional catalyzed resin composition was applied over the chopped glass fiber to form a composite laminate. The composite laminate was allowed to cure at ambient temperature. The composite laminate was 40 wt % glass fiber and 60 wt % resin. The exposed surface of the cured composite laminate was tacky to the touch.

### Example 2

The procedure of Example 1 was repeated to prepare a plurality of composite laminates. Catalyzed resin compositions were prepared by mixing ESCON F61325 NT unsaturated polyester resin with 3% by wt of CUROX-M340 and varying amounts of HEMA, an unsaturated monomer having a hydroxyl functional group. The exposed surface of each cured composite laminate was tacky to the touch.

Composite laminate compositions are shown in the following table. All percentages are by weight.

| | % glass fiber | | |
|---|---|---|---|
| Sample | in composite | % resin composition¹ | % HEMA² in resin |
| No. | laminate | in composite laminate | composition |
| 1 | 40 | 60 | 22 |
| 2 | 40 | 60 | 22 |
| 3 | 35 | 65 | 15 |
| 4 | 35 | 65 | 15 |
| 5 | 35 | 65 | 8 |
| 6 | 35 | 65 | 8 |
| 7 | 40 | 60 | 0 |
| 8 | 40 | 60 | 0 |

¹ESCON F61325 NT + 3% CUROX-M340 + HEMA
²hydroxyethyl methacrylate

Samples of composite laminates were cut into 10 cm by 2.5 cm test strips and two test strips from each composite laminate sample were bonded together using a mixed, two part polyurethane adhesive (Henkel MACOPLAST UK 8101 and MACROPLAST UK 5400) and a 2.5 cm by 2.5 cm overlapped bond area to form a single lap joint shear specimen. The bonded composite structure was allowed to cure at ambient temperature. Composition of the bonded composite structures is shown in the following table.

| | % HEMA | Composite laminate | PU adhesive | PU |
|---|---|---|---|---|
| | in resin | cure time before | ratio by | adhesive |
| Sample | composition by | application of PU | weight (part | cure time |
| No. | wt | adhesive (hours) | A/part B)¹ | (hours) |
| 1 | 22 | 96 | 4:1 | 96 |
| 2 | 22 | 96 | 3.57:1 | 96 |
| 3 | 15 | 16 | 4:1 | 96 |
| 4 | 15 | 16 | 3.57:1 | 96 |
| 5 | 8 | 16 | 4:1 | 96 |
| 6 | 8 | 16 | 3.57:1 | 96 |
| 7 | 0 | 3 | 4:1 | 64 |
| 8 | 0 | 3 | 3.57:1 | 42 |

¹MACOPLAST UK 8101:MACROPLAST UK 5400

Shear strength of the cured composite structure was tested by pulling the lap shear specimens in a tensile test apparatus. Results of the testing are shown in the following table.

| | Shear | |
|---|---|---|
| Sample | strength | |
| No. | (MPa) | Failure mode |
| 1 | 1.6 | Cohesive failure with fibers torn from composite |
| | | laminate |
| 2 | 2.2 | Cohesive failure with fibers torn from composite |
| | | laminate |
| 3 | 2.9 | Cohesive failure with fibers torn from composite |
| | | laminate |
| 4 | 3.1 | Cohesive failure with fibers torn from composite |
| | | laminate |
| 5 | 3.0 | Cohesive failure with fibers torn from composite |
| | | laminate |
| 6 | 3.2 | Cohesive failure with many fibers torn from |
| | | composite laminate |
| 7 | 2.7 | Adhesive failure with no fibers torn from composite |
| | | laminate |
| 8 | 3.2 | Cohesive failure with no fibers torn from composite |
| | | laminate |

Samples 1-6 (all with an unsaturated monomer having a hydroxyl functional group) had desirable cohesive failure modes and sufficient strength to tear fibers from the composite during testing.

Sample 7 (no unsaturated monomer having a hydroxyl functional group) had an undesirable adhesive failure mode.

Sample 8 had a high tensile lap shear strength and desirable cohesive failure mode. However, observation of the failed specimens revealed no fiber tear from the composite. The fillet of adhesive squeezed out from sample 8 was large and the strength results for sample 8 are believed to be due to this extra bond area and are not representative of inherent strength of the adhesive.

### Example 3

The procedure of Example 1 was repeated to prepare a plurality of composite laminates. Catalyzed resin compositions were prepared by mixing ESCON F61325 NT air inhibited unsaturated polyester resin with 3% by wt of CUROX-M340. All percentages are by weight. Sample 9 had 22 wt % HEMA. Sample 10 had no HEMA. The exposed surface of each cured composite laminate was tacky to the touch.

| | | % Resin | | Composite laminate |
|---|---|---|---|---|
| Sample | % glass in | comp. | % HEMA in | cure time before PU |
| ID | laminate | in laminate | Resin comp. | adhesive applied-Hrs |
| 9 | 40 | 60 | 22 | 3 |
| 10 | 40 | 60 | 0 | 3 |

Samples of composite laminates were cut into 10 cm by 2.5 cm test strips and two test strips from each composite laminate sample were bonded together using a mixed, two part polyurethane adhesive (Henkel MACOPLAST UK 8101 and MACROPLAST UK 5400) and a 2.5 cm by 2.5 cm overlapped bond area to form a single lap joint shear specimen. The bonded composite structure was allowed to cure at ambient temperature. Composition of the bonded composite structures is shown in the following table.

| | % | ratio by weight | PU | Tensile | |
|---|---|---|---|---|---|
| | HEMA | of PU | adhesive | shear | |
| Sample | in Resin | adhesive (part | Cure time | strength, | |
| ID | comp. | A/Part B) | @ R.T | MPa | Failure mode |
| 9 | 22 | 4:1 | 64 | 3.1 | 100% Fiber |
| | | | | | tear |
| 10 | 0 | 4:1 | 64 | 2.4 | No fiber |
| | | | | | tear. |

Sample 10 (no unsaturated monomer having a hydroxyl functional group) had a lower strength and showed no fiber tear from the composite laminate. Sample 9 (22 wt % HEMA) had surprisingly improved strength with significant fiber tear.

While preferred embodiments have been set forth for purposes of illustration, the foregoing description should not be deemed a limitation of the disclosure herein. Accordingly, various modifications, adaptations and alternatives may occur to one skilled in the art without departing from the spirit and scope of the present disclosure.

What is claimed:

1. An uncured resin composition comprising an unsaturated resin and an unsaturated monomer having a hydroxyl functional group.

2. The resin composition of claim 1 wherein the unsaturated resin is selected from at least one of unsaturated polyester resin and vinyl ester resin.

3. The resin composition of claim 1 wherein the unsaturated monomer having a hydroxyl functional group comprises a (meth)acrylic monomer having a hydroxyl functional group.

4. The resin composition of claim 1 wherein the unsaturated monomer having a hydroxyl functional group is selected from at least one of glycerol monomethacrylate; 2-hydroxy methacrylate; 2-hydroxyethyl acrylate (HEA); 2-hydroxyethyl methacrylate (HEMA); N-(2-hydroxypropyl)methacrylamide; 3-hydroxypropyl acrylate; hydroxypropyl methacrylate; hydroxyhexyl acrylate; hydroxyoctyl methacrylate; pentaerythritol triacrylate; poly(propylene glycol) monomethacrylate; poly(propyleneglycol) dimethacrylate; 4-methacryloxy-2- hydroxybenzophenone; poly(ethylene glycol)-monomethacrylate; poly(ethylene glycol)-dimethacrylate; poly(ethylene glycol)-diacrylate; poly(ethylene glycol)-monomethylether monomethacrylate.

5. The resin composition of claim 1 comprising a reactive aromatic diluent.

6. The resin composition of claim 1 comprising about 1 wt % to about 30 wt % of the unsaturated monomer having a hydroxyl functional group.

7. The resin composition of claim 1 comprising about 1 wt % to about 10 wt % of the unsaturated monomer having a hydroxyl functional group.

8. A composite laminate comprising an exterior layer of cured reaction products of the resin composition of claim 1 and reinforcement.

9. A composite article comprising a first composite laminate comprising an exterior layer of cured reaction products of the resin composition of claim 1 and reinforcement, the exterior layer being free of secondary treatment; the exterior layer bonded to a substrate surface by cured reaction products of a structural adhesive.

10. The composite article of claim 9 wherein the structural adhesive is a polyurethane adhesive.

11. The composite article of claim 9 wherein the substrate surface comprises a second composite laminate comprising an exterior layer of cured reaction products of the resin composition of claim 1 and reinforcement.

12. The composite article of claim 9 wherein the substrate surface comprises a second composite laminate comprising an exterior layer of cured reaction products of the resin composition of claim 1 and reinforcement, the second composite laminate exterior layer being free of secondary treatment.

13. Use of about 1% to about 30% by weight of resin composition of an unsaturated monomer having a hydroxyl functional group in an unsaturated resin composition to improve bond strength of a composite laminate made using the unsaturated resin composition.

14. A method of improving the bond strength of a composite article, comprising:
adding about 1 wt % to about 30 wt % of an unsaturated monomer having a hydroxyl functional group to an unsaturated resin to form a resin composition;
preparing a composite laminate from the resin composition; and
bonding the composite laminate to a substrate with a structural adhesive;
wherein an exterior layer of the composite laminate without secondary treatment has a higher bond strength to the substrate than an exterior layer of a composite laminate prepared from the resin composition without the unsaturated monomer having a hydroxyl functional group and bonded to the same substrate.
